(19) United States
(12) Patent Application Publication
(10) Pub. No.: US 2015/0109807 A1
(43) Pub. Date: Apr. 23, 2015

(54) VEHICLE LIGHTING DEVICE AND METHOD FOR MANUFACTURING THE SAME

(71) Applicant: HON HAI PRECISION INDUSTRY CO., LTD., New Taipei (TW)

(72) Inventor: PO-CHOU CHEN, Tu-Cheng (TW)

(73) Assignee: HON HAI PRECISION INDUSTRY CO., LTD., New Taipei (TW)

(21) Appl. No.: 14/067,973

(22) Filed: Oct. 31, 2013

(30) Foreign Application Priority Data
Oct. 22, 2013 (TW) 102137997

(51) Int. Cl. F21S 8/10

(52) U.S. Cl. CPC F21S 48/1241; F21S 48/2225
USPC 362/511; 29/832

(57) ABSTRACT

A vehicle lighting device includes a light guiding board and a plurality of LEDs attached to the light guiding board. The light guiding board has a first face, a second face opposite to the first face, a first side face and a second side face connecting the first face and the second face. The LEDs are attached to and face the first side face and the second side face. A light reflecting film is formed on the first face, the second face, the first side face and the second side face. A plurality of light emerging windows are defined in the light reflecting film on the first face. The light emerging windows extend through the light reflecting film. The first face is exposed at the light emerging windows. A method for manufacturing the vehicle lighting device is also provided.

### BACKGROUND

1. Technical Field

The present disclosure generally relates to vehicle lighting devices, and particularly to a vehicle lighting device having a light guiding board and a method for manufacturing the same.

2. Description of Related Art

In recent years, due to excellent light quality and high luminous efficiency, light emitting diodes (LEDs) have increasingly been used as substitutes for incandescent bulbs, compact fluorescent lamps and fluorescent tubes as light sources of illumination devices.

A typical vehicle lighting device is designed like a fish eye, which is called as fish eye lighting device. The lighting device generally includes a fish eye lighting ring. The lighting ring includes an annular light guiding tube. The light guiding tube defines two openings at two ends thereof with LEDs arranged at the openings. When the LEDs are powered, light generated from the LEDs makes the whole light guiding tube light. However, luminance of a part of the light guiding tube remote from the LEDs is less than that of a part of the light guiding tube close to the LEDs, that is to say, the lighting ring is poor in uniformity of luminance.

Therefore, what is needed is to provide an improved vehicle lighting device and method for manufacturing the same which can overcome the above shortcomings.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure.

FIG. 1 is a schematic view of a vehicle lighting device in accordance with an embodiment of the present disclosure.

FIG. 2 is a cross-sectional view of the vehicle lighting device of FIG. 1, taken along a line II-II thereof.

FIG. 3 is flow diagram schematicly showing a method for manufacturing the vehicle lighting device of FIG. 1.

### DETAILED DESCRIPTION

Reference will now be made to the drawings to describe the vehicle lighting device, in detail.

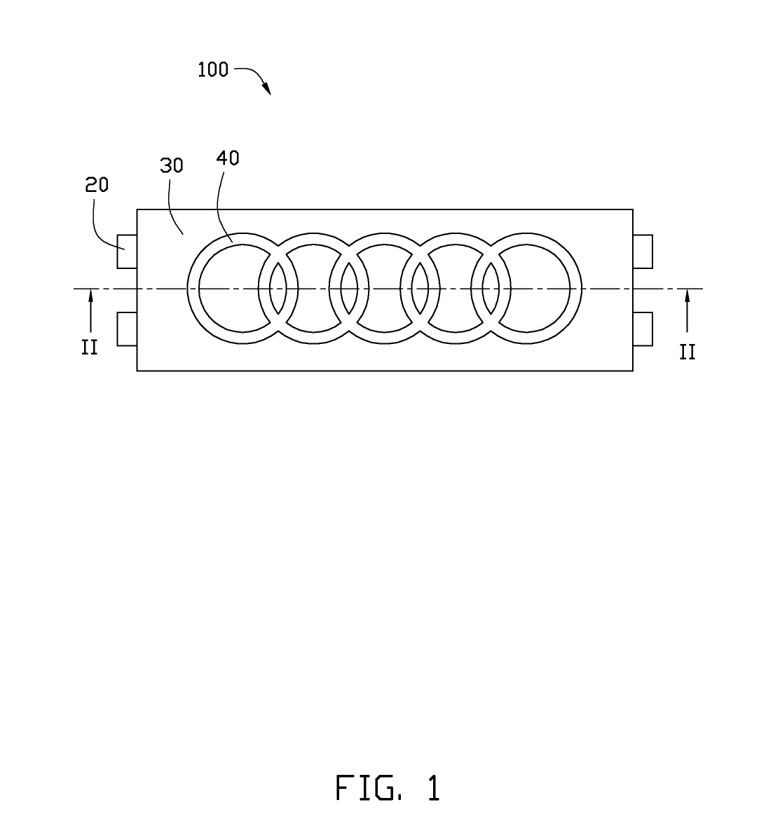

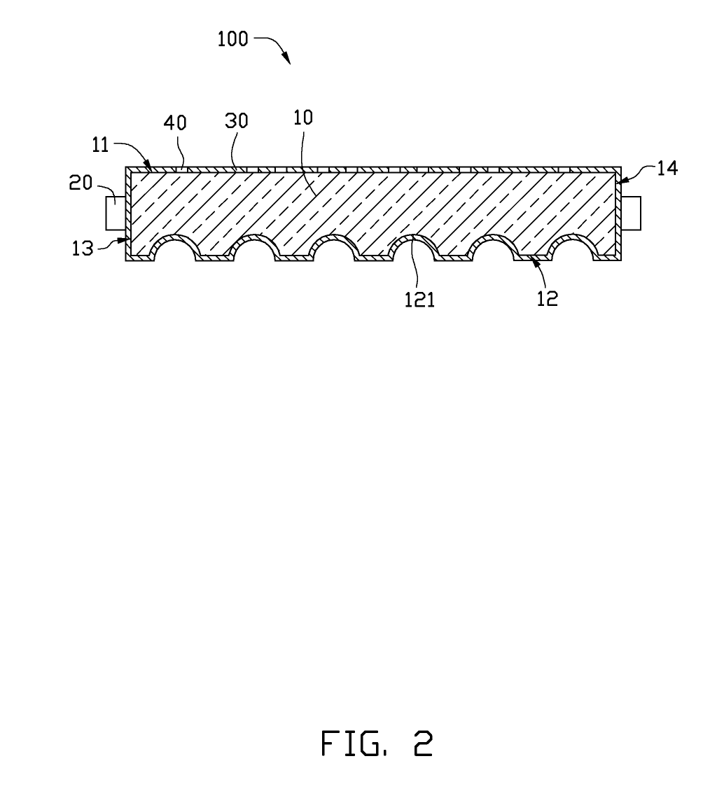

Referring to FIGS. 1-2, a vehicle lighting device 100 according to an embodiment is illustrated. The vehicle lighting device 100 includes a light guiding board 10 and LEDs 20 attached to the light guiding board 10.

The light guiding board 10 is made of transparent material, such as polycarbonate (PC), Polymethyl methacrylate (PMMA) or optical glass. The light guiding board 10 is a substantially rectangular plate. The light guiding board 10 includes a first face 11 and a second face 12 opposite to the first face 11, a first side face 13 and a second side face 14 opposite to the first side face 13. The first side face 13 and the second side face 14 connect the first face 11 and the second face 12. The first face, 11, the first side face 13 and the second side face 14 each are a flat face, i.e., the first face 11, the first side face 13 and the second side face 14 each are in a plane. The second face 12 defines a plurality of grooves 121. The grooves 121 are spaced and parallel to each other. In this embodiment, each groove 121 has an arched cross section.

The vehicle lighting device 100 further includes a light reflecting film 30 attached to the light guiding board 10. The light reflecting film 30 is made of silver, aluminum, nanocomposites or other materials with high light-reflective capacity. The light reflecting film 30 is attached to the whole light guiding board 10, i.e., the light reflecting film 30 is formed on most of all of the first face 11, the second face 12, the first side face 13 and the second side face 14.

A plurality of light emerging windows 40 are defined on the first face 11 of the light guiding board 10 and through the light reflecting film 30 on the first face 11. The first face 11 is exposed at the light emerging windows 40. In this embodiment, the light emerging windows 40 each are a circular ring on the first face 11. The light emerging windows 40 are interconnecting with each other. Two adjacent ones of the circular rings of the lighter emerging windows 40 intersect with each other. The lighter emerging windows 40 cooperatively define a pattern of a plurality of intersecting circular rings.

The LEDs 20 are LEDs emitting visible light when they are excited by electrical current. The LEDs 20 are made of GaN, InGaN, AlInGaN or other suitable semiconductor materials. The LEDs 20 are evenly arranged on and directly face the first side face 13 and the second side face 14. On each of the first side face 13 and the second side face 14, the LEDs 20 are spaced. The LEDs 20 on the first side face 13 are corresponding to the LEDs 20 on the second side face 14.

In this embodiment, the light reflecting film 30 is formed on whole of the first face 11, the second face 12, the first side face 13 and the second side face 14 of light guiding board 10 except where the light emerging windows 40 and the LEDs 20 locate.

When the vehicle lighting device 100 works, light emitted by the LEDs 20 enters the light guiding board 10 via the first side face 13 and the second side face 14, finally emerges out via the windows 40 on the first face 11 of the light guiding board 10. When the light in the light guiding board 10, if the light reaches the first face 11 corresponding the light reflecting film 30, the light is reflected by the light reflecting film 30. If the light reaches the first face 11 corresponding the light emerging windows 40 and with an incident angle less than a total internal reflection angle of the light guiding board 10, the light emerges out via the first face 11 and emits out via the light emerging windows 40. If the light reaches the first face 11 corresponding the light emerging windows 40 and with an incident angle equal or larger than the total internal reflection angle of the light guiding board 10, the light is totally reflected by the first face 11. The light reflected by the first face 11 reaches the first side face 13, the second side face 14 or the second face 12, and is further reflected by the light reflecting film 30 on first side face 13, the second side face 14 or the second face 12, or further reflected by the first face 11, especially, when the light reaches the second face 12, an incident angle of the light is further changed due to the grooves 121 at the second face 12, until the light reaches the first face 11 corresponding to the light emerging windows 40 and with an incident angle less than the total internal reflection angle of the light guiding board 10 and emerges out. Therefore, the light emitted out of the light emerging windows 40 is uniform in luminance when the vehicle lighting device 100 works.

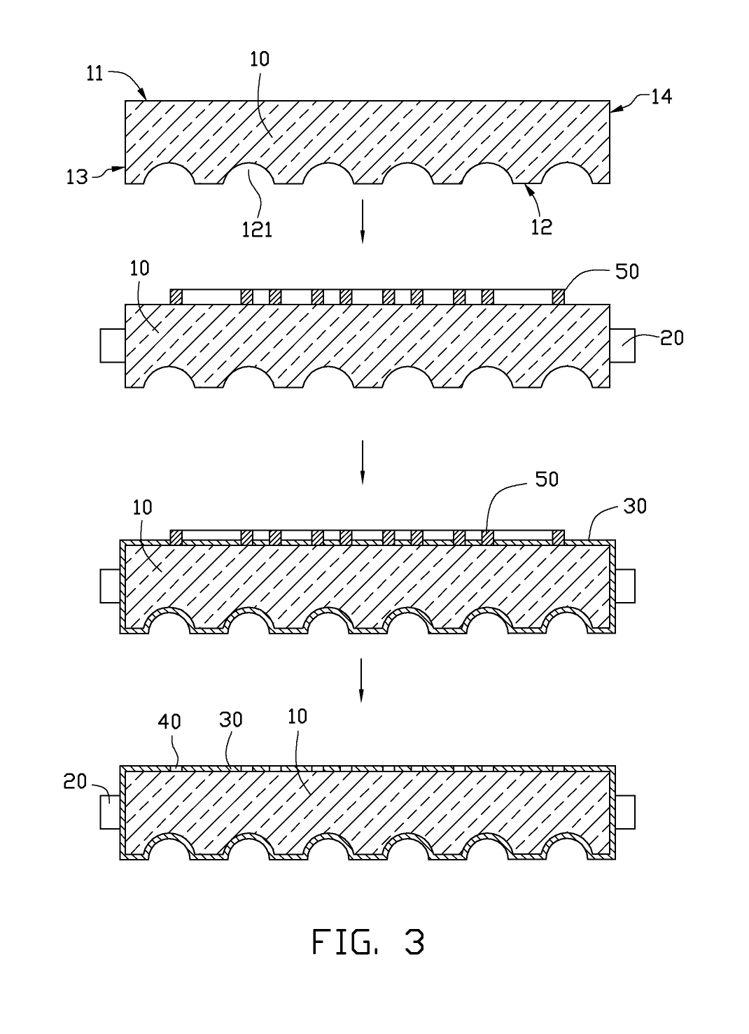

Please referring to FIG. 3, a method for manufacturing the vehicle lighting device 100 is illustrated. The method includes steps as follows.

The light guiding board 10 is provided. The light guiding board 10 includes the first face 11, the second face 12, the second side face 13 and the second side face 14 connecting the first face 11 and the second face 12. The first face 11, the second side face 13 and the second side face 14 each are flat, the second face 12 defines the plurality of spaced grooves 121.

A pattern protecting mask 50 is provided on the first face 11 of the light guiding board 10.

The LEDs 20 are attached to the first side face 13 and the second side face 14 of the light guiding board 10.

The light reflecting film 30 is formed on the first face 11, the second face 12, the first side face 13 and the second side face 14. The light reflecting film 30 is formed on whole of the first face 11, the second face 12, the first side face 13 and the second side face 14 of light guiding board 10 except where the pattern protecting mask 50 and the LEDs 20 locate. In this embodiment, the light reflecting film 30 is formed by the manner of evaporation depositing or sputtering the material of silver, aluminum, nanocomposites or other materials with high light-reflective capacity.

The pattern protecting mask 50 is removed to form the light emerging windows 40 with a pattern identical to that of the pattern protecting mask 50 on the first face 11. In this embodiment, the pattern of the light emerging windows 40 is a plurality of intersecting circular rings.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A vehicle lighting device, comprising:
a light guiding board having a first face, a second face opposite to the first face, a first side face and a second side face opposite to the first side face, the first side face and the second side face connecting the first face and the second face;
a plurality of LEDs attached to and facing the first side face and the second side face of the light guiding board;
a light reflecting film located on the first face, the second face, the first side face and the second side face of the light guiding board; and
a plurality of light emerging windows defined in the light reflecting film on the first face of the light guiding board, for light emitted by LEDs emerging out, the light emerging windows extending through the light reflecting film, the first face of light guiding board being exposed at the light emerging windows.

2. The vehicle lighting device of claim 1, wherein the first face is a flat face.

3. The vehicle lighting device of claim 1, wherein each of the first side face and the second side face is a flat face.

4. The vehicle lighting device of claim 1, wherein the second face defines a plurality of grooves.

5. The vehicle lighting device of claim 4, wherein each of the grooves has an arched cross section.

6. The vehicle lighting device of claim 1, wherein the light reflecting film is on whole of the first face, the second face, the first side face and the second side face of light guiding board except where the light emerging windows and the LEDs locate.

7. The vehicle lighting device of claim 1, wherein the light reflecting film is made of silver, aluminum, nanocomposites or other materials with high light-reflective capacity.

8. The vehicle lighting device of claim 1, wherein the light emerging windows interconnect each other.

9. The vehicle lighting device of claim 8, wherein the light emerging windows intersect each other.

10. The vehicle lighting device of claim 1, wherein each of the light emerging windows is a circular ring.

11. A method for manufacturing a vehicle lighting device, the method comprising:
providing a light guiding board, the light guiding board having a first face, a second face opposite to the first face, a first side face and a second side face opposite to the first side face, the first side face and the second side face connecting the first face and the second face;
providing a pattern protecting mask on the first face of the light guiding board;
attaching a plurality of LEDs to the first side face and the second side face of the light guiding board;
forming a light reflecting film on the first face, the second face, the first side face and the second side face of the light guiding board; and
removing the pattern protecting mask to form a plurality of light emerging windows in the light reflecting film on the first face of the light guiding board.

12. The method of claim 11, wherein the first face of the light guiding board is a flat face.

13. The method of claim 11, wherein each of the first side face and the second side face is a flat face.

14. The method of claim 11, wherein the second face defines a plurality of grooves.

15. The method of claim 14, wherein each of the grooves has an arched cross section.

16. The method of claim 11, wherein the light reflecting film is formed on whole of the first face, the second face, the first side face and the second side face of light guiding board except where the pattern protecting mask and the LEDs locate.

17. The method of claim 11, wherein the light reflecting film is made of silver, aluminum, nanocomposites or other materials with high light-reflective capacity.

18. The method of claim 11, wherein the light reflecting film is formed by a manner of evaporation depositing or sputtering high light-reflective materials.

19. The method of claim 11, wherein the light emerging windows interconnect each other.

20. The method of claim 19, wherein the light emerging windows intersect with each other.
